(19) United States
(12) Patent Application Publication
(10) Pub. No.: US 2011/0145799 A1
(43) Pub. Date: Jun. 16, 2011

(54) PATH-SENSITIVE DATAFLOW ANALYSIS INCLUDING PATH REFINEMENT

(75) Inventor: David Bartolomeo, Woodinville, WA (US)

(73) Assignee: Microsoft Corporation, Redmond, WA (US)

(21) Appl. No.: 12/636,708

(22) Filed: Dec. 12, 2009

(51) Int. Cl. G06F 9/44

(52) U.S. Cl. 717/132; 717/124

(57) ABSTRACT

Methods, systems, and computer-readable media are disclosed to perform path-sensitive dataflow analysis including path refinement. A path-insensitive dataflow analysis may be performed on a control flow graph (CFG) of a computer program to detect a set of potential defects in the computer program. A path-sensitive dataflow analysis may be performed to identify one or more infeasible paths of the CFG without modifying the CFG. Potential defects associated with the one or more infeasible paths may be removed from the set of potential defects to produce a resulting reduced set of potential defects. The resulting reduced set of potential defects may be output.

### BACKGROUND

Dataflow analysis is often used to determine program state with respect to a particular point of a software program. For example, dataflow analysis may track program state at a particular point of a software program and determine whether or not the particular point of the software program contains a programming defect. Dataflow analysis may be path-insensitive or path-sensitive. Path-insensitive dataflow analysis computes program state at the particular point of the software program without regard to the particular execution path taken to reach the particular point. Such path-insensitive dataflow analysis may be relatively efficient (e.g., linear complexity proportional to program length, O(n)), but the results of the path-insensitive dataflow analysis are limited. For example, the results may not detect defects in the software program that appear only when specific execution paths are taken. The results may also report false positives (i.e., defects that do not actually exist in the software program).

Although path-sensitive analysis may be used to improve the accuracy of the analysis, current systems of performing path-sensitive dataflow analysis typically incorporate theorem provers that are more computationally expensive than path-insensitive dataflow analysis. The increase in computational complexity may be at least partly attributed to modification and duplication of control flow graphs that are generated during analysis of the software program. For example, certain systems may generate a new copy of a control flow graph each time a conditional statement is encountered. Thus, such systems may consume a large amount of memory space and processor resources.

### SUMMARY

The present disclosure describes an on-demand path-sensitive dataflow analysis that includes path refinement. Path refinement may provide more accuracy than computationally inexpensive path-insensitive dataflow analysis with less resource consumption than computationally expensive path-sensitive dataflow analysis. Path refinement may also be performed without use of resource-intensive operations, such as use of a theorem prover, modification of control flow graphs (CFGs), and duplication of CFGs.

An initial path-insensitive dataflow analysis is conducted to produce a set of potential defects in a computer program. The potential defects may be examined for infeasible paths, resulting in a reduced set of potential defects. The reduced set of potential defects is more accurate than the original set and may be used to make a defect determination regarding the computer program.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram to illustrate a particular embodiment of a system of performing path-sensitive dataflow analysis including path refinement;

FIG. 2 is a diagram to illustrate representative source code that may be analyzed by the system of FIG. 1;

FIG. 3 is a diagram to illustrate a control flow graph (CFG) associated with the source code of FIG. 2;

FIG. 4 is a diagram to illustrate a particular embodiment of a method of performing a path sensitive dataflow analysis including path refinement with respect to the source code of FIG. 2 and the CFG of FIG. 3;

FIG. 5 is flow diagram to illustrate a particular embodiment of a method of performing path-sensitive dataflow analysis including path refinement;

FIG. 6 is a flow diagram to illustrate another particular embodiment of a method of performing path-sensitive dataflow analysis including path refinement;

FIG. 7 is a flow diagram to illustrate a particular embodiment of a method of performing path refinement that may be used in conjunction with the method of FIG. 6; and

FIG. 8 is a block diagram of a computing environment including a computing device operable to support embodiments of computer-implemented methods, computer program products, and system components as illustrated in FIGS. 1-7.

### DETAILED DESCRIPTION

Systems, methods, and computer-readable media to perform path-sensitive dataflow analysis including path refinement, are disclosed. In a particular embodiment, a computer-readable medium includes instructions that, when executed by a computer, cause the computer to perform a path-insensitive dataflow analysis on a control flow graph (CFG) of a computer program to detect a set of potential defects in the computer program. The computer-readable medium also includes instructions, that when executed by the computer, cause the computer to perform a path-sensitive dataflow analysis to identify one or more infeasible paths of the CFG without modifying the CFG. The computer-readable medium further includes instructions, that when executed by the computer, cause the computer to remove potential defects associated with the one or more infeasible paths from the set of potential defects to generate a reduced set of potential defects. The computer-readable medium includes instructions, that when executed by the computer, cause the computer to output the reduced set of potential defects.

In another particular embodiment, a computer-implemented method is disclosed that includes determining a control flow graph (CFG) for a computer program. The CFG includes a plurality of nodes, where each node represents an execution point of the computer program. The method includes performing a path-insensitive dataflow analysis of the CFG to determine whether a value of a state expression representing program state of the computer program at the particular node is path-insensitive or path-sensitive. When the value of the state expression is path insensitive, the method further includes outputting the path insensitive value. When the value of the state expression is path-sensitive, the method further includes outputting a path-refined value of the state expression, where the path-refined value is determined without modifying the CFG.

In another particular embodiment, a system is disclosed that includes a memory and a processor coupled to the memory. The processor is configured to execute instructions to perform a path-insensitive dataflow analysis with respect to nodes of a control flow graph (CFG) representing source code of a computer program to detect a set of potential defects in the computer program. The processor is also configured to execute instructions to perform a path-sensitive dataflow analysis to identify one or more infeasible paths of the CFG without modifying the CFG. The processor is further configured to execute instructions to remove potential defects associated with the one or more infeasible paths from the set of potential defects to generate a reduced set of potential defects. The processor is configured to execute instructions to output the reduced set of potential defects.

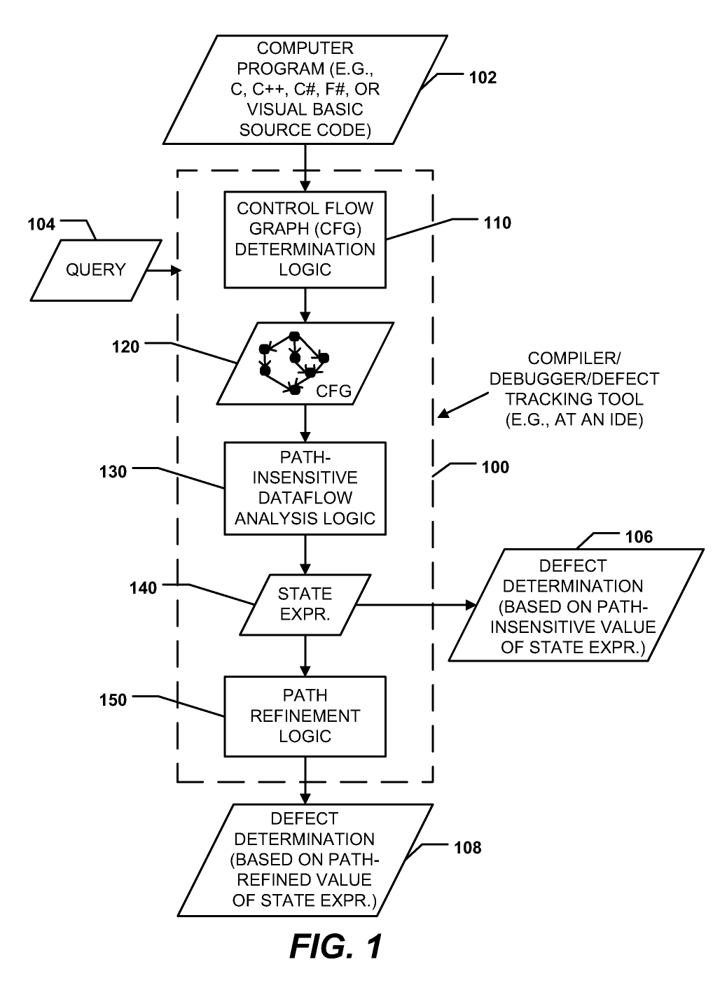

FIG. 1 is a diagram to illustrate a particular embodiment of a system 100 of performing path-sensitive dataflow analysis including path refinement. The system includes control flow graph (CFG) determination logic 110, path-insensitive dataflow analysis logic 130, and path refinement logic 150. In a particular embodiment, the system 100 of FIG. 1 is included in a compiler, a debugger, or a defect tracking tool. For example, the system 100 of FIG. 1 may be provided as a program development tool at an integrated development environment (IDE).

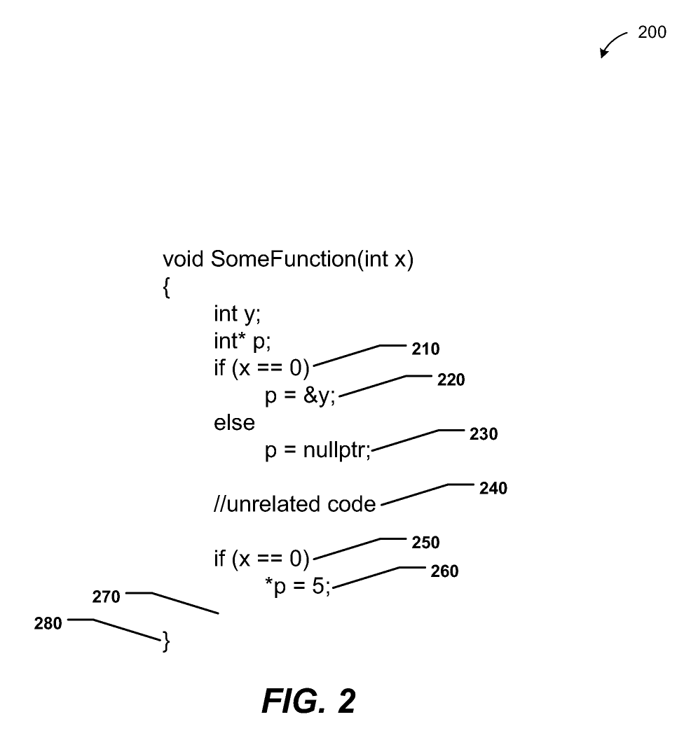

The system 100 of FIG. 1 may receive a query 104 of program state (e.g., values of variables) with respect to a particular execution point of a computer program 102. In a particular embodiment, the computer program 102 is represented by source code. For example, the computer program 102 may be represented as source code in C, C++, C#, F#, Visual Basic, or some other programming language. In a particular embodiment, the query 104 is intended to determine potential defects of the computer program 102. For example, if the particular execution point of the computer program 102 involves dereferencing a pointer variable, the query 104 may be intended to determine whether the pointer variable may be zero or null, where dereferencing a zero or null pointer is a defect that leads to an error condition. An exemplary computer program is further described with reference to FIG. 2.

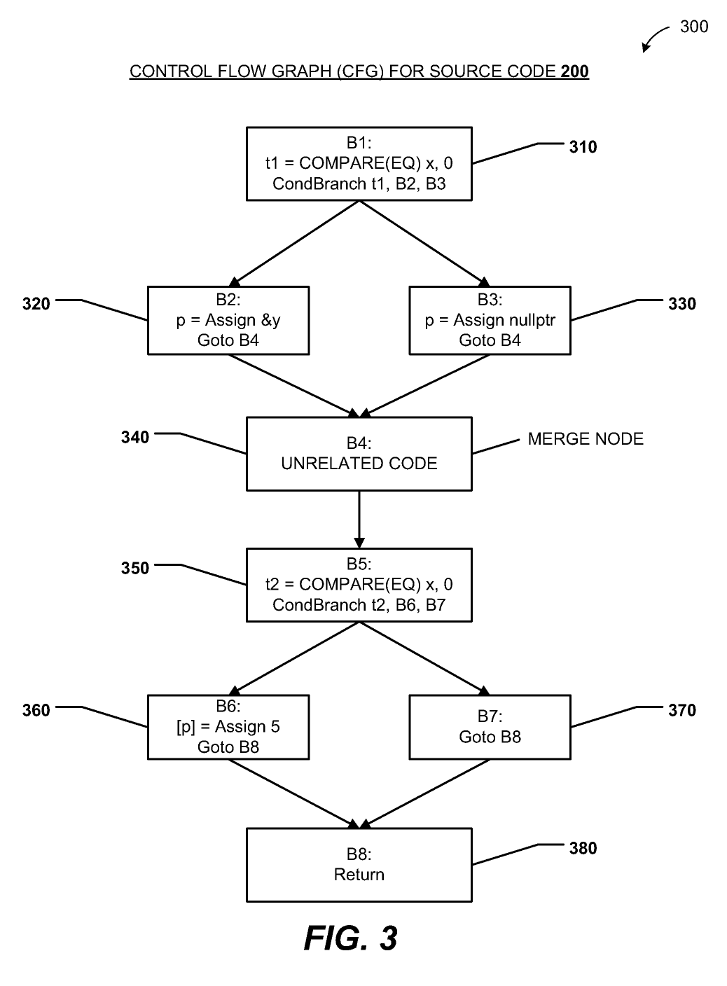

The CFG determination logic 110 may generate a CFG 120 for the computer program 102. In a particular embodiment, the CFG 120 is a directed graph of nodes connected via edges, where each node represents a different execution point of the computer program 102. Thus, the CFG 120 may represent various possible execution paths of the computer program 102. CFG generation is further described with reference to FIG. 3.

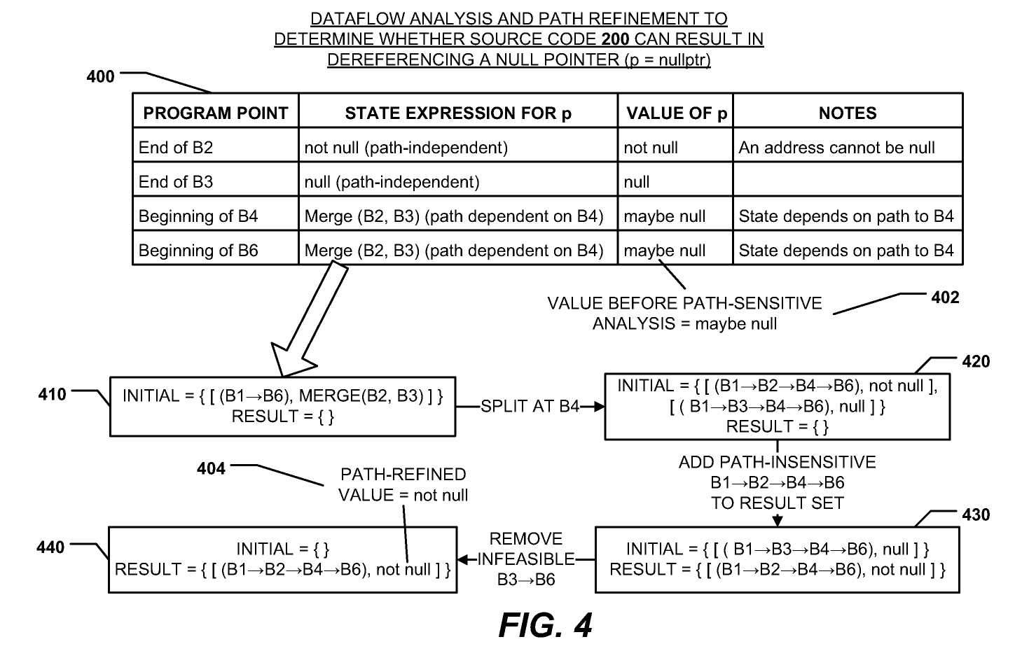

Path-insensitive dataflow analysis logic 130 may perform a path-insensitive dataflow analysis of the CFG 120. For example, the path-insensitive dataflow analysis logic 130 may track program state of the computer program 102 from a beginning of the computer program to the particular execution point of the computer program 102 and may represent the program state at the particular execution point in a state expression 140. When the value of the state expression 140 is path-insensitive, the system 100 may output a defect determination 106 (e.g., a set of potential defects) based on the path-insensitive value of the state expression 140. For example, the system 100 may determine whether or not a pointer that is dereferenced at the particular execution point of a computer program can be zero or null based on a path-insensitive value (e.g., “pointer=always null” or “pointer=always not null”) of a state expression that represents program state at the particular execution point. Path-insensitive dataflow analysis is further described with reference to FIG. 4.

Path refinement logic 150 may perform a path refinement procedure on the state expression 140 when a value of the state expression 140 is path-sensitive (e.g., “pointer=maybe null”). For example, a first execution path leading to the particular execution point may have a state expression “pointer=always null” and a second execution path leading to the particular execution point may have a state expression “pointer=always not null.” Thus, the value of the state expression 140 may be path-sensitive (e.g., “maybe null”), because the value of the state expression 140 depends on whether the first path or the second path is taken to reach the particular execution point.

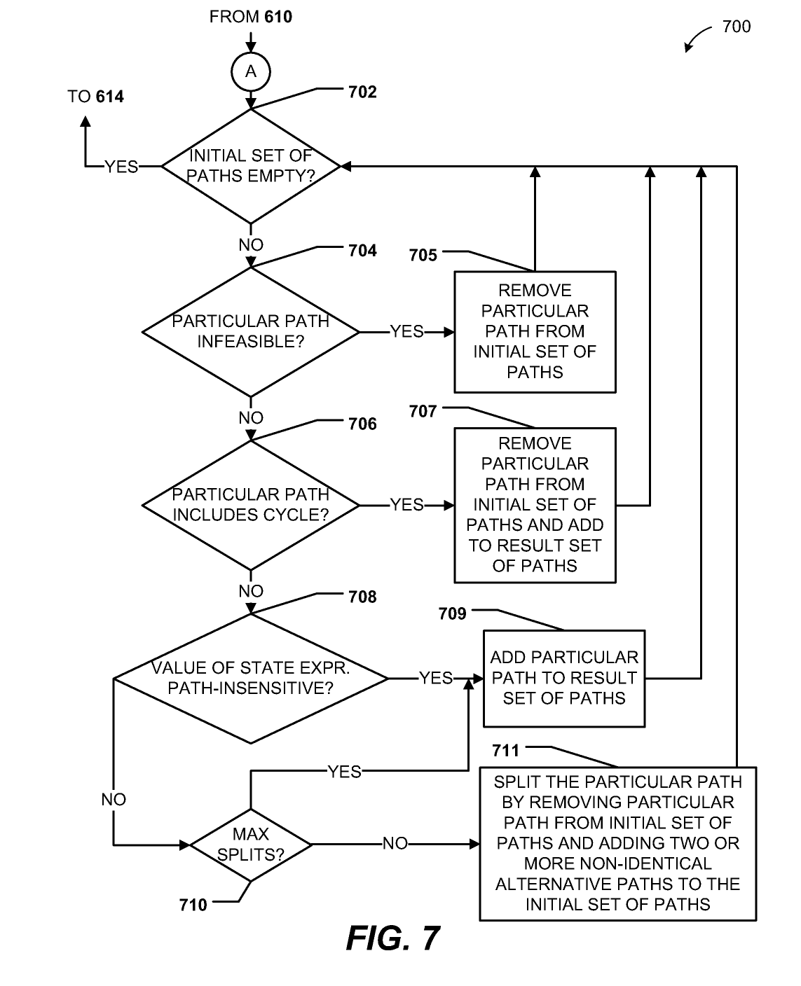

In a particular embodiment, the path refinement procedure includes detecting and removing values associated with infeasible paths of the CFG 120 from the state expression 140. The path refinement procedure may also recursively split sub-paths of the CFG 120. Thus, the path refinement procedure may be considered a path-sensitive dataflow analysis, because execution of the path refinement procedure is dependent on the particular paths of the CFG 120. For example, the path refinement logic 150 may determine a path-refined value (e.g., “pointer=always not null”) of the state expression 140 that is more accurate than the path-sensitive value (e.g., “pointer=maybe null”) of the state expression 140. The system 100 may output a defect determination 108 (e.g., a reduced set of potential defects) based on the path-refined value determined by the path refinement logic 150 based on the state expression 140. Path refinement is further described with reference to FIG. 4 and FIG. 7.

In operation, the CFG determination logic 110 may initiate defect determination via dataflow analysis by determining the CFG 120 for the computer program 102. The path-insensitive dataflow analysis logic 130 may determine a value of the state expression 140 that represents the state of the computer program 102 at a particular execution point (i.e., particular node of the CFG 120). When the value of the state expression 140 is path-insensitive, the system 100 outputs the defect determination 106 based on the path-insensitive value of the state expression 140. When the value of the state expression 140 is path-sensitive, the path refinement logic 150 may determine a path-refined value of the state expression 140. In many cases, the path-refined value is more accurate than the path-sensitive value. The system 100 may output the defect determination 108 based on the path-refined value of the state expression 140. For example, a user of the system 100 may be notified whether the path-refined value indicates a programming defect in the computer program 102.

It will be appreciated that the system 100 of FIG. 1 may provide efficient on-demand path-sensitive dataflow analysis by performing path refinement (e.g., without reference to a theorem prover) when the value of state expression 140 is path-sensitive, but not performing path refinement when the value of the state expression 140 is path-insensitive. It will also be appreciated that the path-sensitive dataflow analysis may be performed without modification or duplication of any nodes of the control flow graph 120, and may be performed without (e.g., prior to) execution of the computer program 102. It will thus be appreciated that the path refinement capability of the system 100 of FIG. 1 may provide more accuracy than computationally inexpensive path-insensitive dataflow analysis with less resource consumption than computationally expensive path-sensitive dataflow analysis.

An exemplary path sensitive dataflow analysis in accordance with the disclosure is further illustrated with reference to FIGS. 2-4. FIG. 2 is a diagram to illustrate a particular example of source code 200 that may be analyzed by the system 100 of FIG. 1. It should be noted that although the source code 200 illustrated in FIG. 2 is a single function, path-sensitive dataflow analysis may performed on source code of any length, including source code projects comprising multiple files. It should also be noted that although the source code 200 illustrated in FIG. 2 is represented as C/C++ statements, the source code 200 may be represented in any computer programming language.

The source code 200 includes two variables: an integer “y” and a pointer to an integer “p.” The source code 200 further accepts an integer “x” as a parameter. Thus, a program state at any line of the source code 200 will include one or more of a value of “y,” a value of “p,” and a value of “x.”

The source code 200 includes a first conditional statement 210. If the value of “x” is equal to zero (e.g., a comparison between the value of “x” and zero is “true”), execution proceeds to a first assignment statement 220, where the value of an address (e.g., in memory) of “y” is assigned to the value of “p.” If the value of “x” is not equal to zero (e.g., the comparison between the value of “x” and zero is “false”), execution proceeds to a second assignment statement 230, where a null pointer value is assigned to the value of “p.” Regardless of which assignment statement 220, 230 is executed, execution then proceeds to the unrelated code portion 240.

After the unrelated code portion 240 is executed, execution proceeds to a second conditional statement 250. Like the first conditional statement 210, the second conditional statement 250 compares the value of “x” with zero. If the comparison is “true,” execution proceeds to a third assignment statement 260, where the value 5 is assigned to the value pointed to by “p.” It will thus be noted that the third assignment statement 260 includes a pointer dereference operation. It will also be noted that if the value (i.e., address) stored in “p” is zero or null, an error condition may arise. Upon completion of the third assignment statement 260, execution proceeds to a function return 280. Alternatively, when the comparison of the second conditional statement 250 is “false,” execution proceeds to the function return 280 via an empty “else” branch 270 of the third conditional statement 250.

It should be noted that although the particular source code 200 illustrated in FIG. 2 includes conditional operations, assignment operations, dereference operations, and return operations, path-sensitive dataflow analysis as described herein may be performed on source code including any programming operation. For example, the source code to be analyzed may also include join points, function calls, and iterative operations.

FIG. 3 is a diagram to illustrate a control flow graph (CFG) 300 associated with the source code 200 of FIG. 2. In the particular embodiment illustrated in FIG. 3, the CFG 300 includes eight nodes 310-380, where each node 310-380 corresponds to an execution point of the source code 200 of FIG. 2.

Control flow begins at node B1 310 corresponding to the first conditional statement 210 of FIG. 2. Node B1 310 includes storing the result of an equality compare operation between “x” and 0 in a temporary location “t1” and performing a conditional branch based on the value of “t1.” If the value of “t1” is true, control flow proceeds to node B2 320. If the value of “t1” is false, control flow proceeds to node B3 330.

At node B2 320 corresponding to the first assignment statement 220 of FIG. 2, the value of an address of “y” is assigned to the value of “p.” At node B3 330 corresponding to the second assignment statement 230 of FIG. 2, a null pointer value is assigned to the value of “p.” Control flow from both node B2 320 and node B3 330 proceeds to node B4 340.

As illustrated in FIG. 3, Node B4 340 is a merge node that is located at the merge of two paths (e.g., B2→B4 and B3→B4) of the CFG 300. Because program state (e.g., the value of “p”) at the node B4 340 depends on whether the path B2→B4 or the path B3→B4 was taken, the program state at the node B4 340 (and subsequent nodes of the CFG 300) may be considered path-sensitive. From node B4 340, control flows to node B5 350 representing the second conditional statement 250. Similar to node B1 310, node B5 350 includes storing the result of an equality compare operation between “x” and 0 in a temporary location “t2” and performing a conditional branch based on the value of “t2.” If the value of “t2” is true, control flow proceeds to node B6 360. If the value of “t1” is false, control flow proceeds to node B7 370.

At node B6 360 corresponding to the third assignment statement 260 of FIG. 2, the value 5 is assigned to the value pointed to by “p.” Thus, node B6 360 includes a pointer dereference operation that may result in an error condition if the value of “p” is zero or null. Control flow from both the node B6 360 and the node B6 370 proceeds to node B8 380 corresponding to the function return 280 of FIG. 2.

FIG. 4 is a diagram to illustrate a particular embodiment of performing a path sensitive dataflow analysis including path refinement with respect to the source code 200 of FIG. 2 and the CFG 300 of FIG. 3. To illustrate, consider an error-checking query of whether or not the source code 200 can include dereferencing a null pointer. Such a query may be made by a compiler (e.g., to generate error messages or warnings while compiling the source code 200 of FIG. 2) or by a defect tracking or debugging tool.

The source code 200 of FIG. 2 and the corresponding CFG 300 of FIG. 3 include one pointer dereference operation—at the third assignment statement 260 of FIG. 2 and the corresponding node B6 360 of FIG. 3. Therefore, the query may be resolved by determining whether the value of “p” immediately prior to the third assignment statement 260 of FIG. 2 and the corresponding node B6 360 of FIG. 3 is zero or null.

A path-insensitive dataflow analysis 400 may initially be performed on the CFG 300 of FIG. 3. During the path-insensitive dataflow analysis 400, a state expression for the value of “p” and the value of “p” may be tracked from node B1 310 of FIG. 3 (e.g., a start of the CFG 300) to node B6 360 of FIG. 3 (e.g., the particular execution point of interest). For example, after node B2 320 of FIG. 3, the state expression for “p” is a path-insensitive expression “not null,” and the value of “p” is “not null,” because “p” is assigned the address of “x” at node B2 320 of FIG. 3 and the address of a C/C++ variable cannot be null. After node B3 330 of FIG. 3, the state expression for “p” is a path-insensitive expression “null,” and the value of “p” is “null,” because “p” is assigned the null pointer value at node B3 330 of FIG. 3.

Immediately prior to the merge node B4 340 of FIG. 3, the state expression for “p” is a merge of the state expressions for B2 320 of FIG. 3 and B3 330 of FIG. 3. Thus, the value of “p” immediately prior to the merge node B4 340 of FIG. 3 is a merge of “null” and “not null,” i.e. “maybe null.” Similarly, the value of “p” immediately prior to the node B6 360 of FIG. 3 is “maybe null.”

Thus, the path-sensitive dataflow analysis 400 results in a path-sensitive value 402 “maybe null,” indicating that the source code 200 may have a programming defect. To improve the accuracy of defect determination, a path-sensitive dataflow analysis may be performed via a path refinement algorithm. In a particular embodiment, the path refinement algorithm is executed based on recursive subdivision of control flow paths as follows:
1) Create an initial set S such that each item in the initial set S is a pair [P, E], where P represents a path and E represents a state expression reflecting program state based on the path P.
2) Create a result set R that is initially empty.
3) For each pair [P, E] in R, until R is empty:
   a) If E is path-sensitive, perform a splitting operation with respect to the pair. During the splitting operation, remove the pair from S and replace the pair with one or more pairs [Pi, Ei], where each Pi represents an alternative path that includes the starting node and ending node of P. Performance of the path refinement algorithm may be selectively adjusted by tracking a total number of splitting operations and treating path-sensitive values of E as path-insensitive values once a maximum number of splitting operations have been performed.
   b) If E is path-insensitive, remove the pair from S and add the pair to R.
   c) If P includes at least one CFG edge more than one time (i.e., a cycle), remove the pair from S and add the pair to R to avoid infinite loops.
   d) If P includes an infeasible path, remove the pair from S. An infeasible path may be a path containing an unreachable edge of the CFG or a path containing two edges of the CFG that are individually reachable but collectively unreachable.
4) Output the combination of state expressions in R as a path-refined value of the initial state expression. When the paths in R do not include any cycles, the combination of state expressions will be path-insensitive.

In accordance with the path-refinement algorithm, an initial set S that includes the pair [(B1→B6), Merge(B2, B3)] and an empty result set R are created at 410. That is, the initial set S includes the path B1→B6 and the corresponding state expression Merge(B2, B3) having the value 402 “maybe null” as determined by the path-insensitive dataflow analysis 400.

Advancing to 420, the path B1→B6 is split because the state expression Merge(B2, B3) is path-sensitive. As illustrated by the CFG 300 of FIG. 3, there are two ways for control flow to proceed from the node B1 310 to the node B6 360—via B2 320 or via B3 330. Thus, the path B1→B6 is split into two paths B1→B2→B4→B6 and B1→B3→B4→B6. After the splitting operation, the initial set S includes a first pair [(B1→B2→B4→B6), not null] and a second pair [(B1→B3→B4→B6), null].

Proceeding to 430, the first pair is examined and added to the result set R because the first pair includes a path-insensitive state expression “not null.” When the second pair is examined, it is determined that the path (B1→B3→B4→B6) is infeasible.

That is, the path (B1→B3→B4→B6) cannot occur during execution of the source code 200 of FIG. 2, because the node B3 330 of FIG. 3 and the node B3 360 of FIG. 3 are on opposite branches of an identical conditional statement “COMPARE(EQ) x, 0.” Thus, the path (B1→B3→B4→B6) includes two CFG edges that are individually reachable but collectively unreachable. Because the path (B1→B3→B4→B6) is infeasible, the second pair is removed from the initial set S. It should be noted that although the particular CFG 300 illustrated in FIG. 3 includes one infeasible path, CFGs may include any number of infeasible paths. Furthermore, a particular path may include any number of infeasible subpaths.

Advancing to 440, the state expression(s) in the result set R are output because the initial set S is empty. That is, a path-refined value 404 “not null” is output, indicating that the source code 200 does not include a programming defect.

It will thus be appreciated that path refinement may improve the accuracy of defect determination by improving the accuracy of state expressions. For example, in the particular embodiment illustrated in FIG. 4, the path-refined value 404 “not null” is more accurate than the value 402 “maybe null” prior to path refinement. It will also be appreciated that this improved accuracy of state expressions may be achieved without modification or duplication of any nodes of the control flow graph CFG 300 of FIG. 3. It will further be appreciated that when path refinement is performed to improve defect determination accuracy, the path refinement is not performed on all paths. Rather, path refinement is only performed on those paths that may influence the defect determination. Thus, in the example above, path refinement was not performed on the unrelated code portion 240 of FIG. 2 and the corresponding node 340 of FIG. 3, or any subpaths thereof.

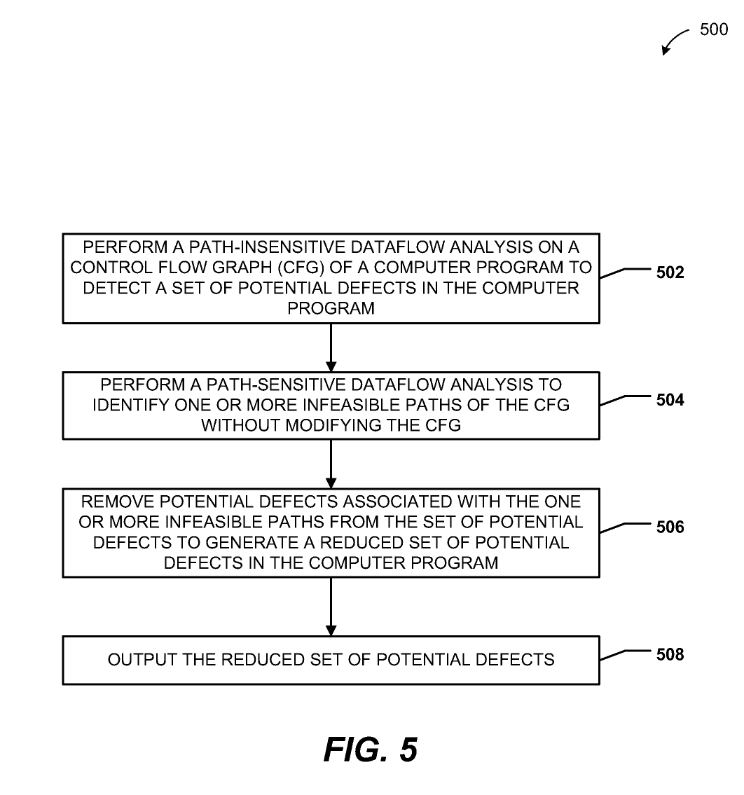

FIG. 5 is flow diagram to illustrate a particular embodiment of a method 500 of performing path-sensitive dataflow analysis including path refinement. In a particular embodiment, the method 500 may be performed by the system 100 of FIG. 1 and is illustrated by the FIGS. 2-4.

The method 500 includes performing path-insensitive dataflow analysis on a control flow graph (CFG) of a computer program to detect a set of potential defects in the computer program, at 502. For example, in FIG. 4, the path-insensitive dataflow analysis 400 may be performed on the CFG 300 of FIG. 3, resulting in the state expression value 402 “maybe null,” indicating a potential defect. The potential defect is included in the initial set at 410.

The method 500 also includes performing a path-sensitive dataflow analysis to identify one or more infeasible paths of the CFG without modifying the CFG, at 504. For example, in FIG. 4, the infeasible path (B1→B3→B4→B6) may be identified.

The method 500 further includes removing potential defects associated with the one or more infeasible paths from the set of potential defects to generate a reduced set of potential defects in the computer program, at 506. For example, in FIG. 4, the infeasible path (B1→B3→B4→B6) and the associated state expression “null” may be removed from the initial set.

The method 500 includes outputting the reduced set of potential defects, at 508. For example, in FIG. 4, an empty set of potential defects may be output because the path-refined value 404 “not null” indicates that there is no programming defect in the source code 200 of FIG. 2.

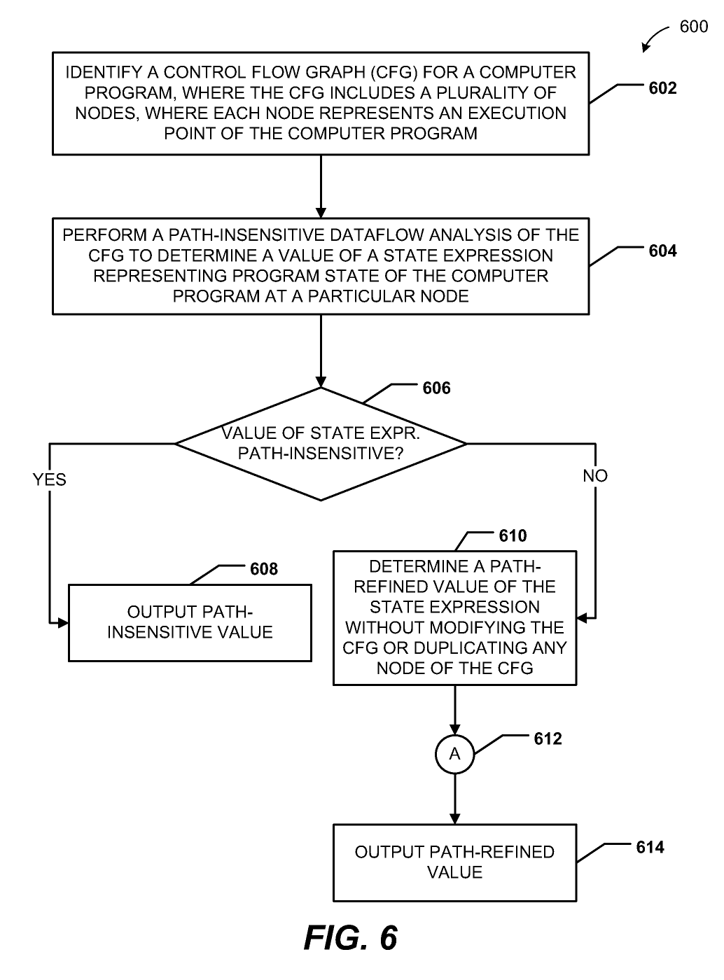

FIG. 6 is a flow diagram to illustrate another particular embodiment of a method 600 of performing path-sensitive dataflow analysis including path refinement. In a particular embodiment, the method 600 may be performed by the system 100 of FIG. 1 and is illustrated by the FIGS. 2-4.

The method 600 includes identifying a CFG for a computer program, at 602. The CFG includes a plurality of nodes, where each node represents an execution point of the computer program. For example, the CFG 300 of FIG. 3 may be identified for the source code 200 of FIG. 2.

The method 600 includes performing a path-insensitive dataflow analysis of the CFG to determine a value of a state expression representing program state of the program at a particular node, at 604. For example, the path-insensitive dataflow analysis 400 of FIG. 4 may be performed to determine the path-insensitive value 402 “maybe null” associated with the node B6 360 of FIG. 3.

The method 600 further includes determining whether the value of the state expression is path-insensitive or path-sensitive, at 606. When the value of the state expression is path-insensitive, the method 600 includes outputting the path-insensitive value, at 608. When the value of the state expression is path-sensitive, the method 600 includes determining a path-refined value of the state expression without modifying or duplicating any node of the CFG, at 610. For example, the path-refined value 404 “not null” may be determined as illustrated in FIG. 4. In a particular embodiment, the path-refined value is determined in accordance with a path-refinement algorithm “A”, at 612. For example, the path refinement algorithm “A” may be the method 700 of FIG. 7.

The method 600 also includes outputting the path-refined value, at 614. For example, the path-refined value 404 of FIG. 4 “not null” may be output.

FIG. 7 is a flow diagram to illustrate a particular embodiment of a method 700 of path refinement that may be used in conjunction with the method 600 of FIG. 6. For example, the method 700 may be performed at “A” 612 of FIG. 6.

The method 700 includes determining whether an initial set of paths is empty, at 702. For example, referring to FIG. 4, the method determines that the set S is not empty at 410, 420, and 430. At 440, the set S is empty. When the initial set of paths is empty, the method 700 terminates. In a particular embodiment, the method 700 terminates by advancing to 614 of FIG. 6.

When the initial set of paths is not empty, the method 700 includes determining whether a particular path in the initial set of paths is infeasible, at 704. When the particular path is infeasible, the method 700 includes removing the particular path from the initial set of paths, at 705. For example, referring to FIG. 4, it may be determined that the path (B1→B3→B4→B6) is infeasible, and the path (B1→B3→B4→B6) may be removed from S, as illustrated at 440. The method 700 returns to 702 from 705.

When the particular path is not infeasible, the method 700 includes determining whether the particular path includes a cycle, at 706. When the particular path includes a cycle, the method 700 includes removing the particular path from the initial set of paths and adding the particular path to a result set of paths, at 707. The method 700 returns to 702 from 707. When the particular path does not include a cycle, the method 700 includes determining whether a value of a state expression associated with the particular path is path-insensitive, at 708. When the value is path-insensitive, the method 700 includes adding the particular path to the result set of paths, at 709. For example, referring to FIG. 4, it may be determined that the state expression value “not null” associated with the path (B1→B2→B4→B6) is path-insensitive, and the path (B1→B2→B4→B6) may be removed from S and added to R, as illustrated at 430. The method 700 returns to 702 from 709.

When the value of the state expression is not path-insensitive, the method 700 includes determining whether a maximum number of splitting operations have been performed, at 710. If the maximum number of splitting operations have been performed, the method 700 includes treating the path-sensitive value of the state expression like a path-insensitive value by advancing to 709. If the maximum number of splitting operations have not been performed, the method 700 includes splitting the particular path, at 711. Splitting the particular path may include removing the particular path from the initial set of paths and adding two or more distinct (e.g., non-identical) alternative paths to the initial set of paths. For example, referring to FIG. 4, the path (B1→B6) may be replaced in S by the non-identical alternative paths (B1→B2→B4→B6) and (B1→B3→B4→B6), as illustrated at 420. The method 700 returns to 702 from 711.

It will be appreciated that the method 700 of FIG. 7 may provide path-sensitive dataflow analysis via path refinement that is less computationally expensive than path-sensitive dataflow analysis involving theorem provers or CFG modification and duplication. It will also be appreciated that the method 700 of FIG. 7 may improve the accuracy of defect determination by improving the accuracy of state expressions. It will further be appreciated that the method 700 of FIG. 7 may selectively refine paths that affect the accuracy of defect determination without examining paths that do not affect the accuracy of defect determination.

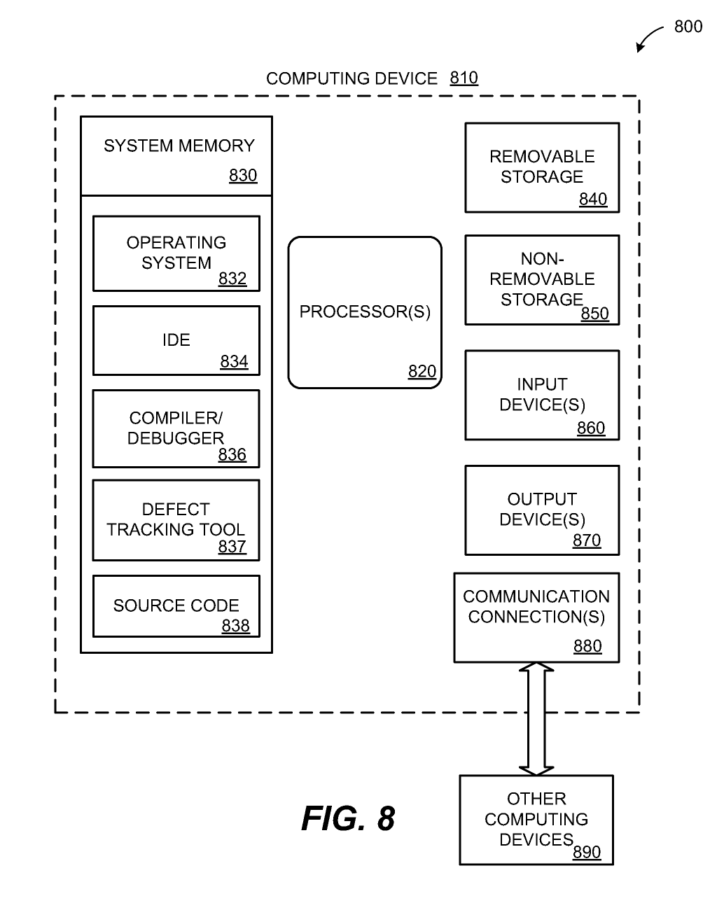

FIG. 8 depicts a block diagram of a computing environment 800 including a computing device 810 operable to support embodiments of computer-implemented methods, computer program products, and system components according to the present disclosure. In an illustrative embodiment, the computing device 810 may include one or more of the CFG determination logic 110 of FIG. 1, the path-insensitive dataflow analysis logic 130 of FIG. 1, and the path refinement logic 150 of FIG. 1. Each of the CFG determination logic 110 of FIG. 1, the path-insensitive dataflow analysis logic 130 of FIG. 1, and the path refinement logic 150 of FIG. 1 may include or be implemented using the computing device 810 or a portion thereof.

The computing device 810 includes at least one processor 820 and a system memory 830. Depending on the configuration and type of computing device, the system memory 830 may be volatile (such as random access memory or “RAM”), non-volatile (such as read-only memory or “ROM,” flash memory, and similar memory devices that maintain stored data even when power is not provided), or some combination of the two. The system memory 830 typically includes an operating system 832, one or more application platforms (e.g., an integrated development environment (IDE) 834), one or more applications (e.g., a compiler/debugger 836 and a defect tracking tool 837), and program data (e.g., source code 838) associated with the one or more applications. In an illustrative embodiment, the IDE 834, the compiler/debugger 836, and the defect tracking tool 837 include one or more of the logic 110, 130, 150 of FIG. 1. In an illustrative embodiment, the source code 838 is a representation of the computer program 102 of FIG. 1 or the source code 200 of FIG. 2.

The computing device 810 may also have additional features or functionality. For example, the computing device 810 may also include removable and/or non-removable additional data storage devices such as magnetic disks, optical disks, tape, and standard-sized or miniature flash memory cards. Such additional storage is illustrated in FIG. 8 by removable storage 840 and non-removable storage 850. Computer storage media may include volatile and/or non-volatile storage and removable and/or non-removable media implemented in any technology for storage of information such as computer-readable instructions, data structures, program components or other data. The system memory 830, the removable storage 840 and the non-removable storage 850 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by the computing device 810. Any such computer storage media may be part of the computing device 810.

The computing device 810 may also have input device(s) 860, such as a keyboard, mouse, pen, voice input device, touch input device, etc. Output device(s) 870, such as a display, speakers, printer, etc. may also be included. The computing device 810 also contains one or more communication connections 880 that allow the computing device 810 to communicate with other computing devices 890 over a wired or a wireless network.

It will be appreciated that not all of the components or devices illustrated in FIG. 8 or otherwise described in the previous paragraphs are necessary to support embodiments as herein described. For example, the removable storage 840 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware, computer software, or combinations of both. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A computer-readable medium comprising instructions, that when executed by a computer, cause the computer to:
perform a path-insensitive dataflow analysis on a control flow graph (CFG) of a computer program to detect a set of potential defects in the computer program;
perform a path-sensitive dataflow analysis to identify one or more infeasible paths of the CFG without modifying the CFG;
remove potential defects associated with the one or more infeasible paths from the set of potential defects to generate a reduced set of potential defects in the computer program; and
output the reduced set of potential defects.

2. The computer-readable medium of claim 1, further comprising instructions, that when executed by the computer, cause the computer to receive a query of program state with respect to a particular node of the CFG, wherein performing the path-insensitive dataflow analysis comprises evaluating a state expression with respect to the particular node of the CFG.

3. The computer-readable medium of claim 2, wherein the path-sensitive dataflow analysis of the CFG is performed in response to determining that the value of the state expression with respect to the particular node of the CFG is path-sensitive.

4. The computer-readable medium of claim 3, wherein the reduced set of potential defects is based on a path-refined value of the state expression that is determined during the path-sensitive dataflow analysis.

5. The computer-readable medium of claim 1, wherein the path-insensitive dataflow analysis and the path-sensitive dataflow analysis are performed prior to execution of the computer program.

6. The computer-readable medium of claim 1, wherein the computer program is represented by source code.

7. A computer-implemented method, comprising:
determining a control flow graph (CFG) for a computer program, wherein the CFG comprises a plurality of nodes, wherein each node represents an execution point of the computer program;
performing a path-insensitive dataflow analysis of the CFG to determine whether a value of a state expression representing program state of the computer program at a particular node is path-insensitive or path-sensitive;
when the value of the state expression is path-insensitive, outputting the path-insensitive value;
when the value is path-sensitive, outputting a path-refined value of the state expression, wherein the path-refined value is determined without modifying the CFG.

8. The computer-implemented method of claim 7, wherein the path-refined value of the state expression is determined without duplicating any node of the CFG.

9. The computer-implemented method of claim 7, wherein the CFG includes at least one merge node representing an execution point of the computer program located at a merge of two or more paths of the CFG.

10. The computer-implemented method of claim 7, further comprising:
determining whether the path-refined value indicates a programming defect; and
notifying a user whether the path-refined value indicates the programming defect.

11. The computer-implemented method of claim 7, wherein the method is performed by a compiler, a debugger, a defect tracking tool, or any combination thereof.

12. The computer-implemented method of claim 7, wherein the method is performed at an integrated development environment (IDE).

13. The computer-implemented method of claim 7, wherein the path-refined value of the state expression is determined without reference to a theorem prover.

14. The computer-implemented method of claim 7, wherein the particular node of the CFG represents an assignment operation, a dereference operation, a join point, a function call, a return operation, a conditional operation, an iterative operation, or any combination thereof.

15. The computer-implemented method of claim 7, wherein the path-refined value of the state expression is determined by:
generating an initial set of paths of the CFG that terminate at the particular node;
until the initial set of paths is empty, for each particular path in the initial set of paths:
when the particular path is infeasible, removing the particular path from the initial set of paths;
when the particular path includes a cycle, removing the particular path from the initial set of paths and adding the particular path to a result set of paths;
when a value of the state expression with respect to the particular path is path-insensitive, adding the particular path to the result set of paths;
when the value of the state expression with respect to the particular path is path-sensitive, performing a splitting operation on the particular path by removing the particular path from the initial set of paths and adding two or more alternative paths to the initial set of paths; and
determining the path-refined value of the state expression that is based on the result set of paths.

16. The computer-implemented method of claim 15, wherein each of the two or more alternative paths are distinct.

17. The computer-implemented method of claim 15, wherein path-sensitive values of the state expression with respect to the particular path are treated as path-insensitive values after a maximum number of splitting operations have been performed.

18. The computer-implemented method of claim 15, wherein the value of the state expression with respect to each path in the result set of paths is path-insensitive when the result set of paths does not include any paths having a cycle.

19. A system, comprising:
a memory; and
a processor coupled to the memory, the processor configured to execute instructions to:
perform a path-insensitive dataflow analysis with respect to nodes of a control flow graph (CFG) of a computer program to detect a set of potential defects in the computer program;
perform a path-sensitive dataflow analysis to identify one or more infeasible paths of the CFG without modifying the CFG;
remove potential defects associated with the one or more infeasible paths from the set of potential defects to generate a reduced set of potential defects in the computer program; and
output the reduced set of potential defects.

20. The system of claim 19, wherein the CFG comprises a plurality of nodes connected via a plurality of edges, and wherein the one or more infeasible paths include a path containing an unreachable edge of the CFG, a path containing two or more edges of the CFG that are individually reachable but collectively unreachable, or any combination thereof.
